(19) United States
(12) Patent Application Publication
(10) Pub. No.: US 2026/0329860 A1
(43) Pub. Date: Oct. 22, 2026

(54) OPTIMIZING QUERY PERFORMANCE WITH ADAPTIVE ENGINE SELECTION IN DATA LAKEHOUSE

(71) Applicant: International Business Machines Corporation, Armonk, NY (US)

(72) Inventors: Kapish Kumar, Bangalore (IN); Yuxiang Cao, Winston Hills (AU); Amitkumar Bamane, Winston Hills (AU); Sachinkumar Jain, Shrewsbury, MA (US)

(21) Appl. No.: 19/185,402

(22) Filed: Apr. 22, 2025

(51) Int. Cl. G06F 16/2453; G06F 11/34; G06F 16/21

(52) U.S. Cl. CPC G06F 16/24542; G06F 11/3409; G06F 16/217

(57) ABSTRACT

Methods for optimizing query performance in a data lakehouse environment are provided. Aspects include receiving a query, analyzing the query to determine a query type and an associated data volume, and obtaining, from a plurality of query engines, execution plans for the query wherein each execution plan comprises operation metrics corresponding to table scans, data redistribution, join operations, and aggregation operations. Aspects also include calculating a query execution score for each of the query execution plan by applying weights to the corresponding operation metrics, selecting an optimal query engine from the plurality of query engines for executing the query based on a comparison of the query execution scores, and automatically routing the query to the optimal query engine for execution.

### BACKGROUND

The present disclosure relates to data management technologies, specifically to optimizing query performance in data lakehouse environments through adaptive engine selection.

In the field of data management, data lakehouses have emerged as a solution for storing and querying vast amounts of data in various formats and structures. Data lakehouse environments provide users with the flexibility to choose from multiple query engines for executing their queries, leveraging shared metadata to retrieve information from diverse data sources. However, the manual selection of query engines often leads to suboptimal results, as users may choose engines based on familiarity rather than efficiency. This approach can be time-consuming and may not utilize the most efficient engine for a given query, especially as data volumes fluctuate over time.

Existing solutions for selecting a query engine typically rely on static rules for engine selection, which lack adaptability and fail to guarantee optimal execution for varying workloads. Users are often required to manually test queries across different engines to identify the most suitable one, a process that demands significant user intervention and expertise. Furthermore, these methods do not account for the dynamic nature of data lakehouse environments, where new engines may be developed and integrated, necessitating a more intelligent and automated approach to engine selection.

### SUMMARY

Embodiments of the present disclosure are directed to computer-implemented methods for optimizing query performance through adaptive engine selection. According to an aspect, a computer-implemented method includes receiving a query, analyzing the query to determine a query type and an associated data volume, and obtaining, from a plurality of query engines, execution plans for the query wherein each execution plan comprises operation metrics corresponding to table scans, data redistribution, join operations, and aggregation operations. The method also includes calculating a query execution score for each of the query execution plan by applying weights to the corresponding operation metrics, selecting an optimal query engine from the plurality of query engines for executing the query based on a comparison of the query execution scores, and automatically routing the query to the optimal query engine for execution.

Embodiments also include computer systems and computer program products for optimizing query performance through adaptive engine selection.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram of an example computer system for use in conjunction with one or more embodiments of the present disclosure;

FIG. 2 depicts a block diagram of a system for optimizing query performance in a data lakehouse environment in accordance with one or more embodiments of the present disclosure; and

FIG. 3 depicts a flowchart of a method for optimizing query performance through adaptive engine selection in a data lakehouse environment in accordance with one or more embodiments of the present disclosure.

### DETAILED DESCRIPTION

In the field of data management, data lakehouses have become a common solution for handling and querying extensive datasets that come in various formats and structures. These environments provide users with the flexibility to choose from multiple query engines to execute their queries, utilizing shared metadata to access information from a wide range of data sources. However, the manual process of selecting query engines often results in less than optimal outcomes, as users may opt for engines based on familiarity rather than performance efficiency. This manual selection can be inefficient and may not leverage the most effective engine for a specific query, especially as data volumes change over time.

Traditional methods for query engine selection often depend on static rules, which lack the flexibility needed to ensure optimal execution across different workloads. Users frequently need to manually test queries on various engines to find the most appropriate one, a task that requires considerable user involvement and expertise. Additionally, these conventional methods do not consider the dynamic nature of data lakehouse environments, where new query engines can be introduced and integrated, highlighting the need for a more intelligent and automated engine selection process.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM) , erasable programmable read-only memory (EPROM or Flash memory), static random access memory (SRAM) , compact disc read-only memory (CD-ROM) , digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as managing a connection pool for cloud-based applications accessing databases (block 150). In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 131, host physical machine set 142, virtual machine set 143, and container set 144.

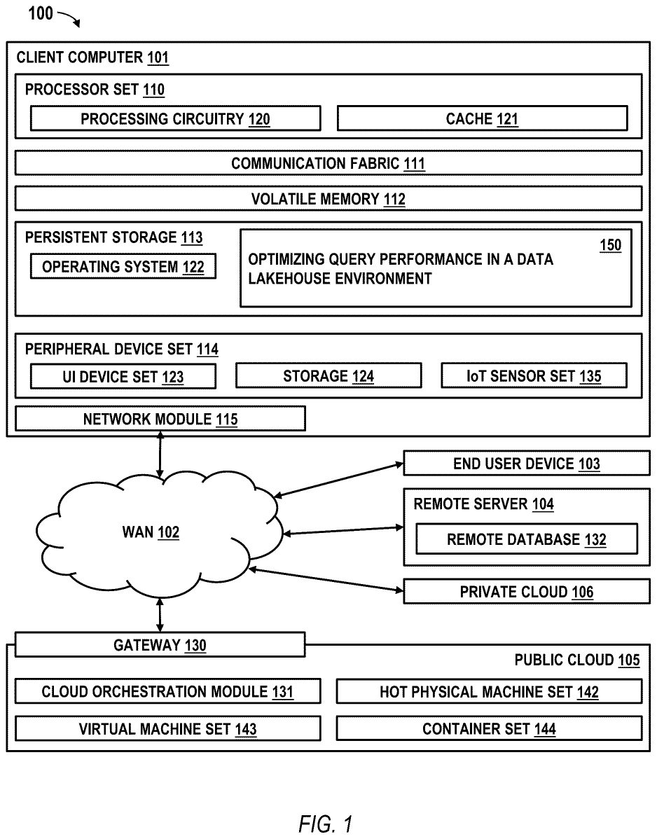

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM) , but typically at least a portion of the persistent storage allows writing of data, deletion of data and re-writing of data. Some familiar forms of persistent storage include magnetic disks and solid state storage devices.

Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward AN Ns that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making AN Ns adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

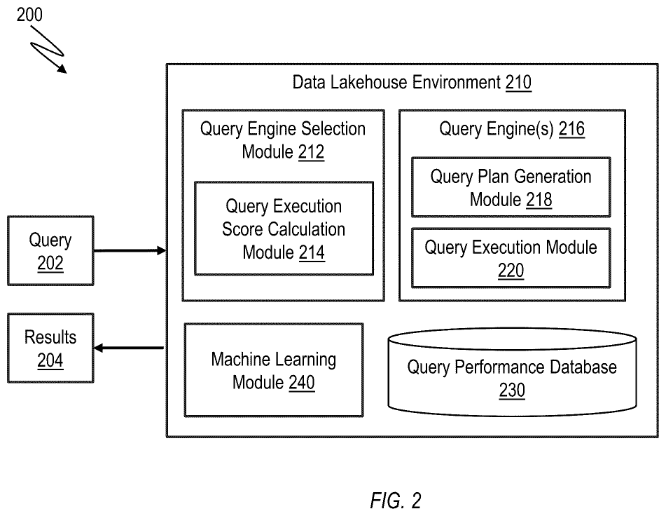

Referring now to FIG. 2, a block diagram of a system 200 for optimizing query performance in a data lakehouse environment 210 in accordance with one or more embodiments of the present disclosure is shown. In exemplary embodiments, the data lakehouse environment 210 is designed to manage and optimize the execution of queries across multiple query engines, leveraging shared metadata to access diverse data sources. The data lakehouse environment 210 facilitates the dynamic selection of query engines, ensuring optimal performance by adapting to changes in data volume and query types. Within this framework, the interaction between components is orchestrated to automate the query execution process, reducing the need for manual intervention and enhancing efficiency.

In exemplary embodiments, the query 202 acts as the initial input into the system, representing the user's request for data retrieval or manipulation within the data lakehouse environment 210. Upon receipt, the query 202 undergoes analysis to determine the type and associated data volume, which are factors in selecting the most suitable query engine for execution. The query 202 initiates the subsequent processes within the system, guiding the flow of operations from engine selection to execution and result generation. In exemplary embodiments, the results 204 are the output of the system, offering the user the data that has been retrieved or manipulated according to the query 202. The results 204 are produced after the query undergoes processing by the chosen query engine, which ensures that the execution is optimized for performance.

In exemplary embodiments, the query engine selection module 212 is responsible for identifying the optimal query engine from a pool of available engines based on the analysis of the query type and data volume. The query engine selection module 212 utilizes execution scores calculated by the query execution score calculation module 214 to compare the performance metrics of different engines. In exemplary embodiments, the selection process is dynamic, adapting to changes in workload and engine capabilities, and is designed to minimize execution time and resource consumption.

In exemplary embodiments, the dynamic selection process begins by continuously monitoring the workload characteristics and the performance metrics of each available query engine. For instance, as data volumes increase or decrease, the system dynamically adjusts the weights assigned to operation metrics such as table scans, data redistribution, join operations, and aggregation operations. This ensures that the query execution score accurately reflects the current capabilities of each engine. For example, suppose a new query engine is integrated into the data lakehouse environment. The system automatically incorporates this engine into the selection process by evaluating its performance through sample executions and historical data analysis. As the new engine demonstrates its efficiency in handling specific query types or data volumes, the system dynamically updates its ranking and selection criteria to include this engine as a viable option. Additionally, if a particular engine experiences a temporary degradation in performance due to high workload or resource constraints, the system detects this change and dynamically shifts the query load to other engines that are better suited to handle the current conditions. This adaptability minimizes execution time and resource consumption by ensuring that each query is routed to the most efficient engine available at any given moment, thereby optimizing overall query performance.

In exemplary embodiments, the query execution score calculation module 214 is configured to evaluate execution plans provided by each query engine. The query execution score calculation module 214 applies weights to operation metrics such as table scans, data redistribution, join operations, and aggregation operations to compute a query execution score for each plan. These scores are used to rank the engines, guiding the query engine selection module 212 in choosing the most efficient engine for executing the query. In exemplary embodiments, the weights may be initially set at default levels, which serve as baseline values for assessing engine performance. These default weights are established based on general expectations of engine capabilities and typical workload characteristics. As queries are executed and performance data is collected, the system observes the actual performance of each query engine in handling different types of operations. This observed performance data is used to modify the default weights, allowing the system to more accurately reflect the strengths and weaknesses of each engine. The modification of weights can be performed using machine learning techniques, which analyze historical execution data to identify patterns and trends in engine performance.

In exemplary embodiments, machine learning models are trained on this historical data to predict future engine performance, enabling the system to dynamically adjust weights in response to changing conditions. For example, if an engine consistently performs well in join operations but struggles with data redistribution, the system may increase the weight assigned to join operations for that engine while decreasing the weight for data redistribution. This adaptive approach ensures that the query execution scores accurately represent the current capabilities of each engine, guiding the query engine selection module 212 in choosing the most efficient engine for executing the query. By continuously refining the weights based on real-time performance data, the system optimizes query execution and enhances overall efficiency.

In one scenario, two different query engines 216, Engine A and Engine B, are available for executing a particular query. The query execution score calculation module 214 evaluates the execution plans provided by each engine, focusing on operation metrics such as table scans, data redistribution, join operations, and aggregation operations.

For Engine A, the execution plan indicates the following operation metrics: Table Scans: 5 operations; Data Redistribution: 3 operations; Join Operations: 4 operations; and Aggregation Operations: 2 operations. The default weights for these operations are initially set as follows: Table Scans: 1; Data Redistribution: 2; Join Operations: 3; and Aggregation Operations: 1. The query execution score for Engine A is calculated by applying these weights to the respective operation metrics:

Score for Engine A=(5×1)+(3×2)+(4×3) +(2×1)=5+6+12+2=25 For Engine B, the execution plan indicates the following operation metrics:

Table Scans: 4 operations; Data Redistribution: 4 operations; Join Operations: 3 operations; and Aggregation Operations: 3 operations. The default weights for Engine B are set differently to reflect its unique performance characteristics: Table Scans: 2; Data Redistribution: 4; Join Operations: 2; and Aggregation Operations: 2. The query execution score for Engine B is calculated by applying these distinct weights to the respective operation metrics: Score for Engine B=(4×2)+(4×4)+(3×2)+(3×2)=8+16+630 6=36. In this example, Engine B has a higher query execution score of 36 compared to Engine A's score of 25. Therefore, the query engine selection module 212 would rank Engine B higher and select it as the optimal engine for executing the query based on the calculated scores. As more queries are executed and performance data is collected, these weights can be adjusted using machine learning techniques to better reflect the actual performance of each engine, further refining the selection process.

In exemplary embodiments, the default weights assigned to operation metrics, such as table scans, data redistribution, join operations, and aggregation operations, reflect the relative performance characteristics of each query engine. These weights are established based on initial assessments of the engines' capabilities and typical workload profiles. For instance, an engine that excels in data redistribution may be assigned a higher weight for this metric, while an engine that performs better in join operations may receive a greater weight for join-related tasks. By customizing the default weights for each engine, the system can more accurately evaluate and rank the engines' execution plans, ensuring that the selection process accounts for the inherent strengths and weaknesses of each engine. This approach allows the system to optimize query execution by leveraging the most suitable engine for the specific operational demands of a given query, thereby enhancing overall performance and efficiency.

In exemplary embodiments, the query engine(s) 216 represent the diverse set of engines available within the data lakehouse environment for processing queries. Each query engine 216 possesses distinct capabilities and performance characteristics, which are assessed during the engine selection process. The query engine(s) 216 interact with other components such as the query plan generation module 218 and the query execution module 220 to generate execution plans and carry out the query operations, respectively.

In exemplary embodiments, the query engine(s) 216 may include, but are not limited to, Apache Spark, Presto, Apache Hive, Netezza, IBM Db2, Apache Impala, and Google BigQuery. Apache Spark is known for its ability to handle large-scale data processing and real-time analytics, making it suitable for complex computations and iterative algorithms. Presto, a distributed SQL query engine, is optimized for speed and efficiency, particularly for running interactive analytic queries on large datasets. Apache Hive is primarily used for data warehousing tasks and supports SQL-like queries, making it ideal for batch processing. Netezza offers high-performance analytics as a data warehouse appliance, optimized for handling large volumes of data. IBM Db2 provides robust data processing capabilities and supports advanced analytics as a relational database management system. Apache Impala is designed for interactive data analysis on Hadoop, known for its low-latency SQL queries. Google BigQuery, a serverless, highly scalable, and cost-effective multi-cloud data warehouse, is designed for business agility. These engines interact with other components, such as the query plan generation module 218 and the query execution module 220, to generate execution plans and carry out query operations, ensuring optimal query execution.

In exemplary embodiments, the query plan generation module 218 is responsible for developing execution plans for the query across various engines. These plans detail the operations needed to process the query, such as scans, joins, and aggregations. The query plan generation module 218 ensures that the plan for each engine is customized to align with the engine's particular architecture and capabilities, offering a foundation for calculating execution scores and selecting the appropriate engine. In exemplary embodiments, the query execution module 220 is responsible for executing the query using the selected engine. The query execution module 220 implements the operations specified in the execution plan, coordinating the retrieval and manipulation of data to produce the results 204.

In exemplary embodiments, the query performance database 230 maintains historical data on query executions, serving as a reference for evaluating engine performance and enhancing the selection process. Updates to the query performance database 230 include execution outcomes, allowing the system to learn from previous experiences and enhance decision-making capabilities. The stored data is utilized for calculating weights and execution scores, facilitating the system's adaptation to changing workloads and engine advancements.

In exemplary embodiments, the machine learning module 240 enhances the system's ability to select the optimal query engine by applying machine learning techniques to analyze historical performance data and to update weights used by the query execution score calculation module 214. The machine learning module 240 can retrain models with new execution data, continuously improving the accuracy of engine selection. By incorporating machine learning, the system can predict engine performance more effectively, adapting to changes in query types and data volumes to maintain optimal execution efficiency.

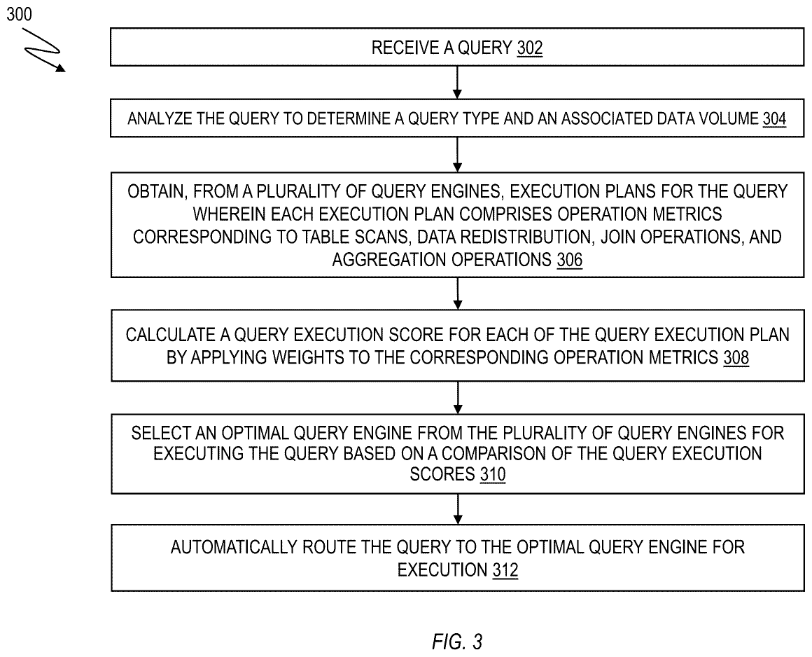

Referring now to FIG. 3, a flowchart of a method for optimizing query performance through adaptive engine selection in a data lakehouse in accordance with one or more embodiments of the present disclosure is shown. In one embodiment, the method 300 is performed by a data lakehouse environment 210, such as the one shown in FIG. 2. At block 302, the method 300 includes receiving a query submitted to the data lakehouse instance. This query serves as the initial input to the system, initiating the process of engine selection and execution optimization.

Next, as shown at block 304, the method 300 involves analyzing the query to determine a query type and an associated data volume. This analysis may include identifying whether the query is a Data Manipulation Language (DML) or Data Query Language (DQL) query. In exemplary embodiments, the optimal query engine is further selected based on the query type.

As shown at block 306, the method 300 also includes obtaining execution plans from a plurality of query engines, where each execution plan includes operation metrics such as table scans, data redistribution, join operations, and aggregation operations. This step may involve invoking a daemon process to request and retrieve execution plans from the query engines. Next, as shown at block 308, the method 300 includes calculating a query execution score for each execution plan by applying weights to the corresponding operation metrics. In exemplary embodiments, these weights may be based on default values, historical query execution performance data, or sample executions.

The method 300 further includes selecting an optimal query engine from the plurality of query engines for executing the query based on a comparison of the calculated query execution scores, as shown at block 310. This step involves evaluating the query execution scores that have been computed for each engine, which reflect the performance potential of each engine in handling the specific query. The scores are derived from applying weights to operation metrics such as table scans, data redistribution, join operations, and aggregation operations, as previously calculated. To perform this selection, the system ranks the query engines according to their execution scores, with higher scores indicating better suitability for the query at hand. The engine with the highest score is deemed the most optimal for executing the query, as it is expected to deliver the best performance in terms of execution time and resource efficiency. This ranking process may also consider additional factors such as current workload conditions, engine availability, and historical performance data stored in a query performance database.

Next, as depicted at block 312, the method involves automatically routing the query to the selected optimal query engine for execution. This step is initiated once the optimal query engine has been identified based on the comparison of query execution scores. The query engine selection module automatically directs the query to the chosen engine, ensuring that the execution process is seamless and efficient. The query engine selection module may incorporate feedback loops that monitor the execution process and adjust routing decisions in real-time to accommodate changes in engine performance or workload conditions. This adaptive approach ensures that the query is executed with minimal delay and optimal resource utilization, enhancing the overall efficiency and responsiveness of the data lakehouse environment. By automating the routing process, the system reduces the need for manual intervention, allowing users to focus on higher-level data analysis tasks.

In exemplary embodiments, the method may involve analyzing the query structure to identify multiple sub-queries and corresponding operations, with the query execution score computed as an aggregate of weighted metrics for each sub-query. This analysis begins by decomposing the main query into its constituent sub-queries, each representing a distinct operation or set of operations within the overall query framework. These sub-queries may include operations such as table scans, data redistribution, join operations, and aggregation operations, each contributing to the overall execution complexity and resource requirements. Once the sub-queries are identified, the system evaluates the operation metrics associated with each sub-query, applying weights to these metrics based on historical performance data or predefined criteria. The weights reflect the relative importance and resource consumption of each operation, allowing the system to assess the execution efficiency of each sub-query independently. For example, a sub-query involving complex join operations may be assigned higher weights for join-related metrics, while a sub-query focused on data retrieval may prioritize table scan metrics. The query execution score for the entire query is then computed as an aggregate of the weighted metrics for each sub-query. This aggregate score provides a comprehensive view of the query's execution potential, taking into account the performance characteristics of each sub-query and their combined impact on the overall query execution. By analyzing the query structure in this manner, the system can more accurately determine the optimal query engine for executing the query, ensuring that each sub-query is handled by the engine best suited to its specific operational demands. This approach allows the system to optimize query execution by leveraging the strengths of different engines for different sub-queries, thereby enhancing overall performance and efficiency. The system may also incorporate machine learning techniques to refine the weights and improve the accuracy of the aggregate score, adapting to changes in query types and data volumes to maintain optimal execution efficiency.

In exemplary embodiments, the determination of whether a query is a DM L or DQL query can influence the selection of the optimal query engine. For instance, if the query is identified as a DM L query, which involves operations such as INSERT, UPDATE, DELETE, or CREATE, the system may prioritize engines that are optimized for data modification tasks. An engine like Apache Spark, known for its robust data processing capabilities and efficient handling of large-scale data transformations, might be preferred for such operations due to its ability to efficiently manage data ingestion and modification tasks. Conversely, if the query is identified as a DQL query, which primarily involves data retrieval operations such as SELECT statements, the system may favor engines that excel in executing complex queries with high efficiency and speed. For example, Presto, a distributed SQL query engine optimized for running interactive analytic queries, might be selected for its ability to quickly process large datasets and deliver results with low latency. By analyzing the query type, the system can tailor the engine selection process to leverage the specific strengths of each engine, ensuring that the chosen engine is well-suited to handle the particular demands of the query. This targeted approach enhances overall query performance and resource utilization, aligning the engine's capabilities with the operational requirements of the query.

In exemplary embodiments, the query engine selection module dynamically selects the most suitable query engine by evaluating execution plans using a score threshold that is adjusted based on historical performance data stored in a query performance database. The score threshold can be recalibrated dynamically to account for changes in data volume, query complexity, or the addition of new query engines to the system. For example, the score threshold may be lowered for queries involving large data volumes to prioritize engines with enhanced data redistribution capabilities. In another embodiment, the score threshold is determined using real-time sampling of query execution performance across multiple engines. In this case, the system executes a subset of the query on each engine and calculates the threshold based on the observed performance metrics, such as execution time or resource utilization. In yet another embodiment, the score threshold is derived from a machine learning model trained on historical query execution data. The model predicts the appropriate threshold for a given query based on its structure, type, and associated data volume, enabling the system to adapt to evolving workloads and query patterns. Additionally, the query engine selection module may implement a hybrid approach where the score threshold is initially set using historical data but is refined through real-time sampling or machine learning predictions to ensure effective engine selection.

The descriptions of the various embodiments of the present disclosure have been presented for purposes of illustration, but are not intended to be exhaustive or limited to the embodiments disclosed. M any modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method for optimizing query performance in a data lakehouse environment, the method comprising:
receiving a query;
analyzing the query to determine a query type and an associated data volume;
obtaining, from a plurality of query engines, execution plans for the query wherein each execution plan comprises operation metrics corresponding to table scans, data redistribution, join operations, and aggregation operations, wherein the operation metrics comprise operation counts for the respective operation types;
calculating a query execution score for each execution plan by applying weights to the corresponding operation metrics as a weighted sum of the operation metrics corresponding to the table scans, data redistribution, join operations, and aggregation operations;
selecting an optimal query engine from the plurality of query engines for executing the query based on a comparison of the query execution scores; and
automatically routing the query to the optimal query engine for execution.

2. The method of claim 1, wherein analyzing the query comprises determining whether the query type is a Data Manipulation Language (DML) query or a Data Query Language (DQL) query and wherein the optimal query engine is further selected based on the query type.

3. The method of claim 1, wherein the weights are based on historical query execution performance data stored in a query performance database.

4. The method of claim 1, wherein the weights are based on sample query executions performed by the plurality of query engines.

5. The method of claim 1, further comprising updating a query performance database with execution outcomes associated with table scans, data redistribution, join operations, and aggregation operations for refining subsequent query engine selections.

6. The method of claim 1, wherein the plurality of query engines comprise SPARK, Presto, Netezza, and DB2, and wherein the query execution score is further determined by comparing ranks assigned to each engine for table scan performance, data redistribution efficiency, join operation performance, and aggregation operation performance.

7. The method of claim 1, wherein the weights are obtained from a machine learning model and wherein the method further comprises retraining the machine learning model with execution performance data of the execution of the query by the optimal query engine.

8. The method of claim 1, wherein automatically routing the query to the optimal query engine for execution comprises dynamically selecting the query engine based on a score threshold derived from the weighted operation metrics of the execution plans.

9. The method of claim 1, wherein analyzing the query further comprises determining a query structure that identifies multiple sub-queries and corresponding operations, and wherein the query execution score is computed as an aggregate of weighted metrics for each sub-query.

10. A computing system comprising:
a processor;
a memory coupled to the processor; and
one or more computer readable storage media coupled to the processor, the one or more computer readable storage media collectively containing instructions that are executed by the processor via the memory to cause the processor to perform operations comprising:
receiving a query;
analyzing the query to determine a query type and an associated data volume;
obtaining, from a plurality of query engines, execution plans for the query wherein each execution plan comprises operation metrics corresponding to table scans, data redistribution, join operations, and aggregation operations, wherein the operation metrics comprise operation counts for the respective operation types;
calculating a query execution score for each execution plan by applying weights to the corresponding operation metrics as a weighted sum of the operation metrics corresponding to the table scans, data redistribution, join operations. and aggregation operations;
selecting an optimal query engine from the plurality of query engines for executing the query based on a comparison of the query execution scores; and
automatically routing the query to the optimal query engine for execution.

11. The computing system of claim 10, wherein analyzing the query comprises determining whether the query type is a Data Manipulation Language (DML) query or a Data Query Language (DQL) query and wherein the optimal query engine is further selected based on the query type.

12. The computing system of claim 10, wherein the weights are based on historical query execution performance data stored in a query performance database.

13. The computing system of claim 10, wherein the weights are based on sample query executions performed by the plurality of query engines.

14. The computing system of claim 10, wherein the operations further comprise updating a query performance database with execution outcomes associated with table scans, data redistribution, join operations, and aggregation operations for refining subsequent query engine selections.

15. The computing system of claim 10, wherein the plurality of query engines comprise SPARK, Presto, Netezza, and DB2, and wherein the query execution score is further determined by comparing ranks assigned to each engine for table scan performance, data redistribution efficiency, join operation performance, and aggregation operation performance.

16. The computing system of claim 10, wherein the weights are obtained from a machine learning model and wherein the operations further comprise retraining the machine learning model with execution performance data of the execution of the query by the optimal query engine.

17. The computing system of claim 10, wherein automatically routing the query to the optimal query engine for execution comprises dynamically selecting the query engine based on a score threshold derived from the weighted operation metrics of the execution plans.

18. The computing system of claim 10, wherein analyzing the query further comprises determining a query structure that identifies multiple sub-queries and corresponding operations, and wherein the query execution score is computed as an aggregate of weighted metrics for each sub-query.

19. A computer program product having one or more computer readable storage media having computer readable program code collectively stored on the one or more computer readable storage media, the computer readable program code being executed by a processor of a computer system to cause the computer system to perform operations comprising:
receiving a query;
analyzing the query to determine a query type and an associated data volume;
obtaining, from a plurality of query engines, execution plans for the query wherein each execution plan comprises operation metrics corresponding to table scans, data redistribution, join operations, and aggregation operations, wherein the operation metrics comprise operation counts for the respective operation types;
calculating a query execution score for each of execution plan by applying weights to the corresponding operation metrics as a weighted sum of the operation metrics corresponding to the table scans, data redistribution, join operations, and aggregation operations;
selecting an optimal query engine from the plurality of query engines for executing the query based on a comparison of the query execution scores; and
automatically routing the query to the optimal query engine for execution.

20. (canceled)

21. The method of claim 1, wherein the weights are default weights customized for each query engine to reflect relative performance characteristics of the query engine for table scans, data redistribution, join operations, and aggregation operations.
